(19) United States
(12) Patent Application Publication
(10) Pub. No.: US 2005/0146143 A1
(43) Pub. Date: Jul. 7, 2005

(54) Universal stop for a slidable window

(76) Inventor: Anthony G. Lutfallah, Des Plaines, IL (US)

Correspondence Address: PAUL J. NYKAZA, ESQ.;WALLENSTEIN WAGNER & ROCKEY, LTD., 53RD FLOOR, 311 SOUTH WACKER DRIVE, CHICAGO, IL, 60606-6630, US

(21) Appl. No.: 10/752,406

(22) Filed: Jan. 6, 2004

(51) Int. Cl. E05C 1/04

(52) U.S. Cl. 292/153

(57) ABSTRACT

A window stop is provided. The window stop includes a housing defining a cavity and having mount structure. The mount structure is adapted to be mounted to a wall having a thickness between a range of thicknesses from a minimum to a maximum thickness. A bolt is mounted within the cavity and moveable between a retracted position wherein the bolt is substantially located within the housing and a locking position wherein the bolt extends from within the cavity. Also provided is means for releasably holding the bolt in the retracted position and biasing means between the housing and the bolt for biasing the bolt towards the extended position.

### TECHNICAL FIELD

This invention relates generally to a device for selectively limiting the movement of a sliding member and more particularly concerns a window stop for selectively limiting the movement of a window that slides either horizontally or vertically along a track, the stop capable of being mounted in window frames or sash windows having frame members of varying thicknesses.

### BACKGROUND OF THE INVENTION

Sliding window assemblies often include a pair of window sashes. One assembly is commonly referred to as a double-hung sash window. A double-hung window typically includes a window frame and a pair of window sashes mounted for vertical sliding movement, one relative to the other, within the window frame. Another window assembly may generally be referred to as a horizontal sliding window. A horizontal sliding window also includes a window frame and pair of window sashes mounted for lateral sliding movement, one relative to the other, within the window frame. Although in the past, window assemblies traditionally were made exclusively of wood, window assemblies are increasingly being formed of extruded plastic or metal frame members which are joined at mitered corners, to form a generally rectangular frame in which glazing is mounted. Examples of these types of window assemblies are shown in FIGS. 1 and 2.

In these window assemblies, it is important to be able to selectively limit the distance the sliding window sash may travel. For example, a window sash may be partially opened, enough to allow for venting, while still inhibiting egress in or out through the window.

To selectively limit the movement of the sliding window sash, window stops have been developed. One type of window stop is shown in U.S. Pat. Nos. 4,824,154; 4,923,230 and 5,248,174, having the same assignee as the present invention. This window stop is a compact unit typically mounted in a stile of a window frame (See FIG. 1). The window stop generally includes a tumbler within a housing. The tumbler rotates out of the housing and extends into the path of a sliding window sash thus limiting movement of the sash. While this window stop has been very effective in this application, the amount of force that the tumbler can absorb is limited. In some applications, too much force can be delivered from the sliding window. The high impact of the sliding window against the stop causes the tumbler to over rotate, sometimes breaking the window stop.

A second type of window stop is shown in U.S. Pat. No. 5,553,903, having the same assignee as the present invention. This window stop can be mounted in a track of a sliding window (See FIG. 2) and can also be mounted in a stile of a window frame like the stop shown in FIG. 1. This window stop generally includes a bolt and latch within a housing. By operating the latch, the bolt extends directly out of the housing into the path of a sliding window sash, thus limiting movement of the sash. The bolt does not rotate out of the housing. This second window stop has guides between the housing and bolt that increases the resistive areas over which forces may be transferred. Consequently, this window stop can absorb greater forces than the window stop having the rotating tumbler. This window stop has also been very effective in this application. Because the window stop housing has separate cavities to accommodate the latch and bolt, however, the stop is not as compact in size. In addition, the second window stop is more costly than the window stop having the rotating tumbler.

Also, window stops of all types include some means for mounting the stop usually within a vertical stile of the upper sash window. As noted above, sash windows are now being formed of extruded plastic or metal frame members which are joined at mitered corners, to form a generally rectangular frame. This results in an essentially hollow sash window frame. Window stops are typically mounted such that a housing of the stop is substantially positioned within a frame member of the hollow sash, with a cover of the housing resting on an outer surface of a wall of the frame member. To secure the stop within the sash, a wall of the frame member is received between the cover and a tab extending from the housing. In the past, the cover and the tab(s) for any given window stop have been capable of being mounted in a frame member having a wall of only a single thickness. This causes window stop manufacturers to produce multiple housings based on anticipated frame member or wall thicknesses. This increases attendant costs. This also causes window manufacturers and assemblers to stock and inventory multiple window stops depending upon anticipated frame member thicknesses, increasing attendant costs for the window manufacturer.

The present invention is provided to solve these and other problems.

### SUMMARY OF THE INVENTION

A stop is provided for limiting movement of a sliding window or door along a predetermined path of window movement. The window stop includes a housing defining a cavity and having mount structure. The mount structure is adapted to be mounted to a wall having a thickness between a range of thicknesses from a minimum thickness to a maximum thickness. A bolt is mounted within the cavity and moveable between a retracted position wherein the bolt is substantially located within the housing and a locking position wherein the bolt extends from within the cavity. Also provided is means for releasably holding the bolt in the retracted position and biasing means between the housing and the bolt for biasing the bolt towards the extended position.

According to another embodiment of the invention, the mount structure includes a cover extending beyond a side wall of the housing to define a lip and a resilient tab having a base portion mounted to the side wall. The tab has an engagement surface spaced from and in opposed relation to the lip wherein the lip and the surface are configured to receive a portion of the wall therebetween.

According to another embodiment of the invention, the engagement surface is inclined with respect to the lip.

According to another embodiment of the invention, the engagement surface generally faces away from the side wall.

According to another embodiment of the invention, the engagement surface comprises a ridge. The engagement surface may also comprise a plurality of ridges. In certain preferred embodiments, the engagement surface may comprise two ridges or three ridges.

According to another embodiment of the invention, the engagement surface comprises a protrusion. The engagement surface may also comprise a plurality of protrusions.

According to another embodiment of the invention, the housing further comprises a bump extending from an exterior surface of the housing. The bump may also cooperate with a recess in an aperture of the wall.

Other features and advantages of the invention will be apparent from the following specification taken in conjunction with the following drawings.

### BRIEF DESCRIPTION OF THE DRAWINGS

The universal stop for a slidable window of the invention will now be described with reference to the accompanying drawings, in which:

FIG. 1 is a fragmentary front elevational view of a double-hung window assembly depicting a prior art window stop installed in an upper stile of a window frame;

FIG. 2 is a fragmentary perspective view of a sliding window assembly depicting another prior art window stop installed in a window track of a window frame;

FIG. 3 is a perspective view of an embodiment of a window stop of the present invention;

FIG. 4 is an elevational view of the window stop of FIG. 3 showing a bolt and actuator in a locked position;

FIG. 5 is an exploded view of the window stop of FIG. 3 further including a cover plate;

FIG. 6 is another exploded view of the window stop of FIG. 3 further including a cover plate;

FIG. 7 is a front elevational view of the window stop of FIG. 3 showing the actuator pivoted to unlock the bolt and having a portion of a faceplate removed to show the entire actuator;

FIG. 8 is a front elevational view of the window stop of FIG. 3 showing the bolt unlocked and in an extended position;

FIG. 9 is a perspective view of the window stop of FIG. 3 showing the bolt unlocked and in an extended position;

FIG. 10 is a partial cross-sectional view of a window stop having a prior art housing and mounted in a frame member of a sash window;

FIG. 11 is another partial cross-sectional view of a window stop having a prior art housing and mounted in a window sash;

FIG. 12 is a partial cross section of a window stop having a housing of the present invention mounted in a frame member of a sash window;

FIG. 13 is a partial cross-sectional view of a window stop having a housing of the present invention mounted in a frame member of a sash window;

FIG. 14 is a partial cross-sectional view of the window stop of FIG. 12 mounted in a frame member of a sash window;

FIG. 15 is a partial cross-sectional view of a window stop having a housing of an alternative embodiment of the present invention;

FIG. 16 is an exploded isometric view of a window stop mounted in a frame member of a sash window having a housing of an alternative embodiment of the present invention; and

FIG. 17 is a perspective view of an alternative window stop embodying the present invention.

### DETAILED DESCRIPTION

While this invention is susceptible of embodiments in many different forms, there is shown in the drawings and will herein be described in detail, a preferred embodiment of the invention with the understanding that the present disclosure is to be considered as an exemplification of the principles of the invention and is not intended to limit the broad aspects of the invention to the embodiment illustrated.

Referring to the drawings, FIG. 1 shows a prior art window stop 11 being used in a sash window assembly 1. The window assembly 1 includes a master frame 2 having an upper sash window 3 and a lower sash window 4 slidably mounted therein. Each sash window 3, 4 has a top rail 5, bottom rail 6 and a pair of vertical stiles 7. Each stile 7 is typically hollow and includes a front wall or frame member 8. The prior art window stop 11 is shown installed in the vertical stile 7 of the upper sash window 3, being mounted to the front wall 8 thereof.

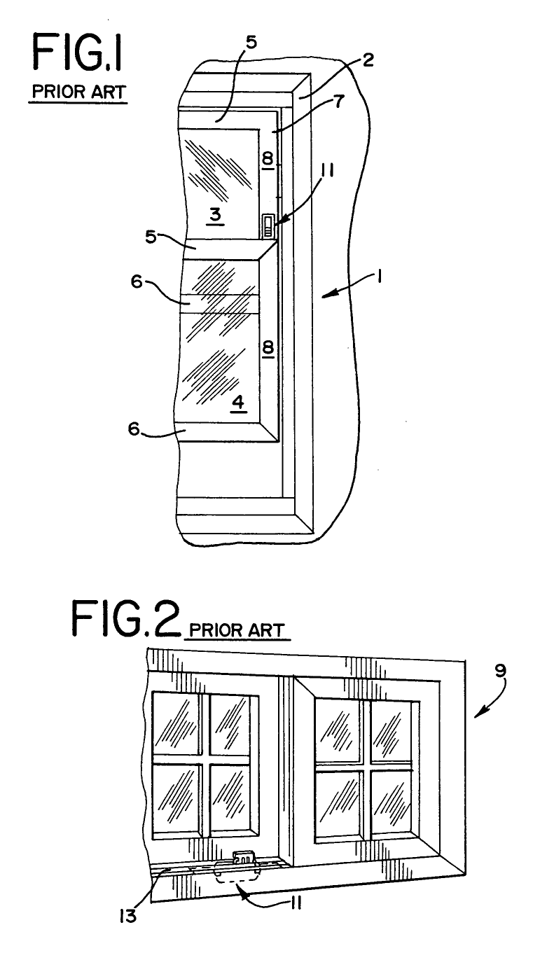

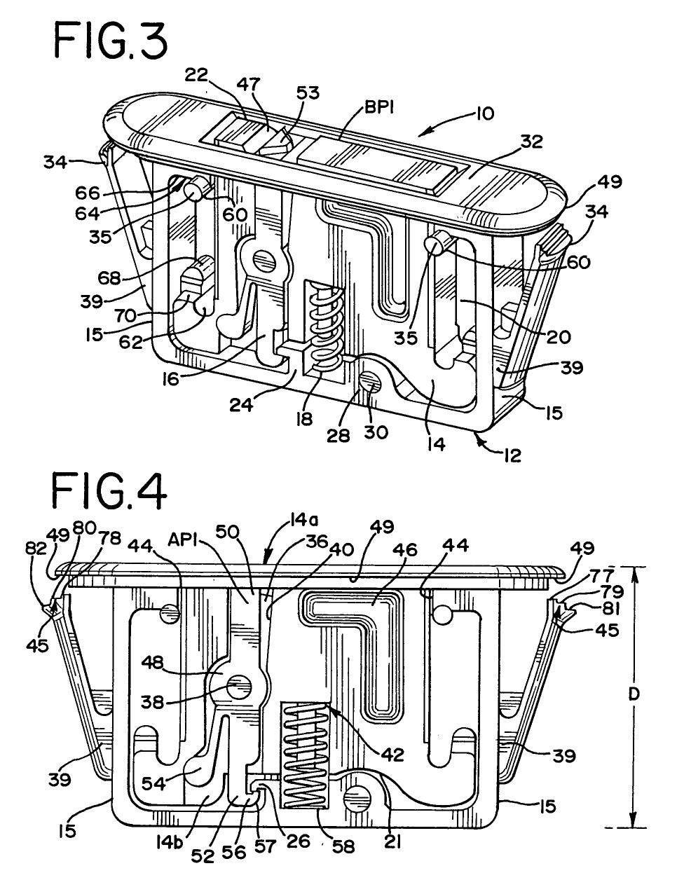

FIG. 2. shows a horizontally sliding window assembly 9. The prior art window stop 11 is shown installed in a lower track 13 of the assembly 9. However, the window stop 10 (FIG. 3) of the present invention can be used for a vertically sliding window assembly, or for a sliding door assembly. Additionally, features of the housing (to be described) of the window stop 10 of the present invention can be utilized in any window or door hardware adapted to be mounted in a frame member.

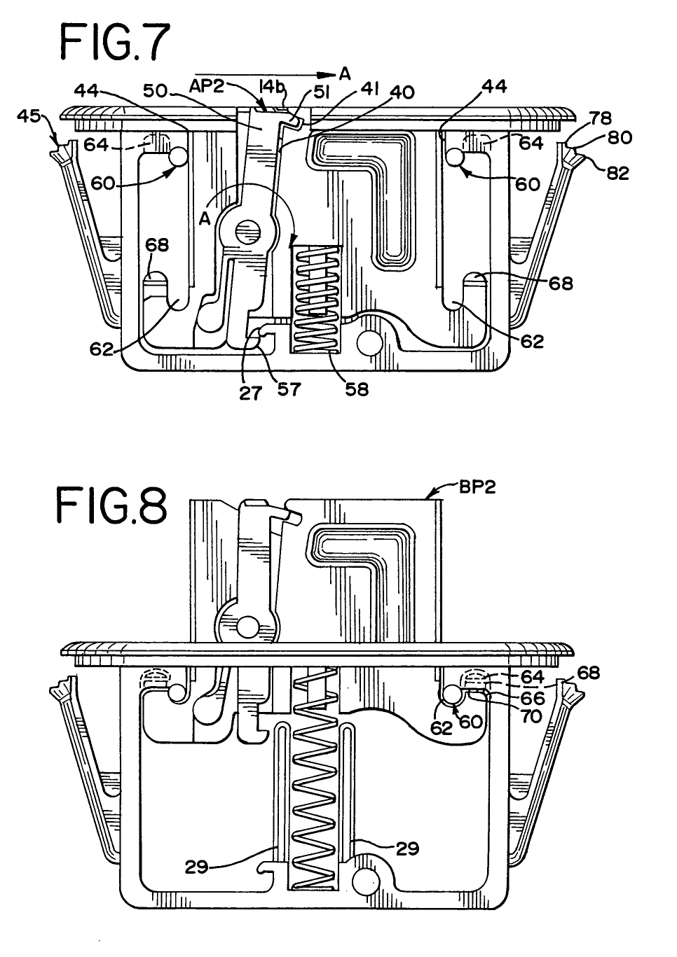

In one preferred embodiment, FIG. 3 shows a window stop of the present invention generally designated by the reference numeral 10. The window stop 10 generally includes a housing 12, a bolt 14, an actuator 16, and a means for biasing the bolt 18. Generally, the housing 12 has a body 17 that is installed into a window track or sash stile of a sliding window. The bolt 12 is moveable between a first or retracted position BP1 (FIG. 3), out of the path of window movement, and a second or extended position BP2 (FIG. 8), into the path of window movement. The actuator 16 is moveable between a first or locked position AP1 (FIG. 4), locking the bolt 14 in its first position BP1, and a second or released position AP2 (FIG. 7) that allows the bolt 14 to extend to its second position BP2. The structure and assembly of the window stop 10 will first be described and then the operation and installation of the window stop 10 will be described.

As the window stop 10 is installed in either a stile or track of a sliding window, the housing 12 is advantageously narrow to allow for such installation. As shown in FIG. 3, the housing 12 has a body 17 that defines cavity 20 that receives the bolt 14, actuator 16 and means for biasing 18. The housing 12 and cavity 20 are generally square-shaped although other configurations are possible such as rectangular. In addition, the housing 12 can be made of varying depths “D” (FIG. 4) such as when installed in window tracks or sash stiles of varying depths. At a top end, the housing 12 has an opening 22 in communication with the cavity 20. The opening 22 allows the bolt 14 to extend therethrough to its second position BP2. The housing 12 has a first projection 24 located on a bottomwall of the housing 12 that extends into the cavity 20. The first projection 24 has a pin 26 having a cam surface 27 (FIG. 4). The pin 26 cooperates with the actuator 16 to be described below. A second projection 28 is also located on a bottomwall of the housing 12, spaced from the first projection 24. A pair of ribs 29 (FIG. 8) extend along a backwall of the housing 12 from the first and second projections 24, 28. The projections 24, 28 and ribs 29 cooperate to assist in containing the means for biasing 18 as will be described. The housing 12 also has opposing internal surfaces 44 (FIG. 4) that guide the bolt 14 as the bolt 14 extends from its first position BP1 to its second position BP2.

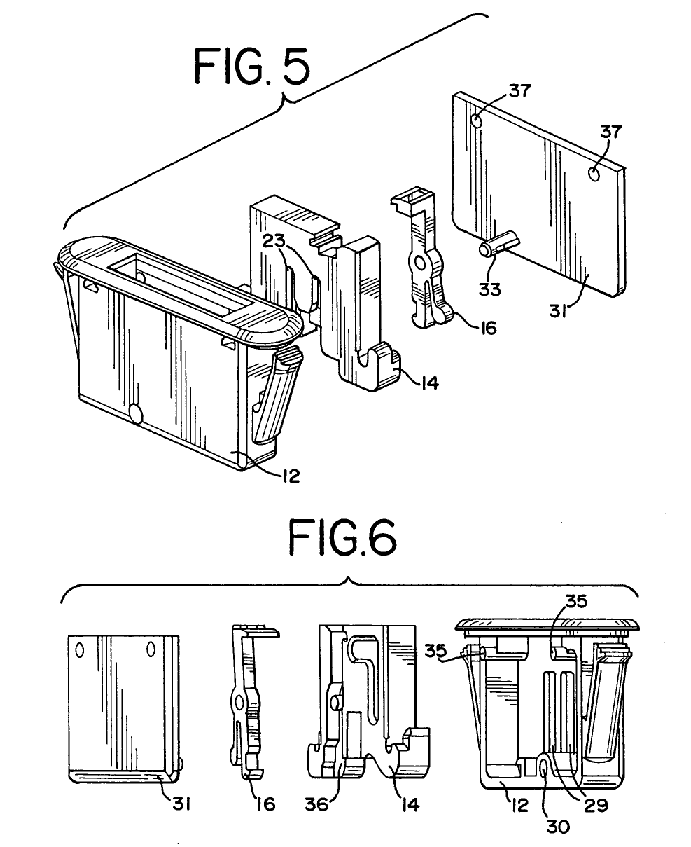

As shown in FIGS. 5 and 6, the housing 12 also has a cover plate 31 that completely encloses the bolt 14 and actuator 16 in the cavity 20 of the housing 12. The cover plate 31 is not shown in FIGS. 3, 4 and 6-9 in order to show the internal structure of the window stop 10. The housing 12 has a hole 30 located in the second protrusion 28 of the housing 12 and a pair of locators 35 located on opposite sides of the housing 12 (FIG. 6). The cover plate 31 has a ribbed peg 33 and a pair of shallow indentations 37 (FIG. 5). When the cover plate 31 is joined to the remainder of the housing 12, the hole 30 receives the ribbed peg 33 in an interference fit. The locators 35 abut the indentations 37.

As further shown in FIG. 3, a faceplate or cover 32 is included with the housing 12. The faceplate 32 is a solid member of minimal thickness and is integral with the housing 12. The faceplate 32 extends slightly forward of a track or stile of a sliding window so as not to interfere with the relative movement of the sliding window. The faceplate 32 has an opening corresponding to the opening 22 of the cavity 20 to allow the bolt 14 to extend therethrough. The faceplate 32 also extends beyond the remainder of the housing 12 to form a generally peripheral lip 49.

To retain the housing 12 within a track 13 or stile of a window frame, the housing 12 has a pair of integrally formed resilient clips or tabs 34 located on opposite exterior or end walls 15 of the housing 12. The clips or tabs 34 include a base portion 39 at one end and mounted to or integral with a respective end wall 15. The tabs 34 also have an engagement surface 45 distal from the base portion 39 and spaced from and generally opposed to the lip 49. Further details regarding the structure for mounting the housing 12, and the function of same, will be discussed below.

As shown in FIG. 4, the bolt 14 is generally square-shaped and configured to fit within the cavity 20 and inside of surfaces 44 of the housing 12. The bolt 14 has a recess 36 extending into the thickness of the bolt that accommodates the actuator 16. The recess 36 extends longitudinally from a top end 14a of the bolt 14 to a bottom end 14b of the bolt 14. The recess has a bevelled surface 47 (FIG. 3) at the top end 14a of the bolt 14. The recess 36 also has an inclined surface 40 with a notch 41 (FIG. 7) on one side to allow the actuator 16 to pivot as will be described. A post 38 is integrally formed in the recess 36 to pivotally support the actuator 16. The bolt 14 also has a slot 42 that receives the means for biasing 18. The slot 42 includes a spring post 53 for receiving the means for biasing 18, when the said means comprises a helical spring. The spring post 53 is not necessary, however, as the means for biasing will be contained by the cover plate 31 and a backwall of the housing 12. It is understood that the means for biasing 18 may comprise any biasing means known in the art such as a spring or any other resilient member. The means for biasing 18 may also be integral with the bolt 14 or housing 12. The bolt 14 has a cut-out portion 21 at its bottom end 14b to accommodate the projections 24, 28 when the bolt 14 is in its first position BP1. As shown in FIG. 5, the bolt 14 has a pair of second cut-out portions 23 that accommodate the ribs 29 on the housing 12. The bolt 14 further may have a core 46 (FIG. 4) for injection molding purposes. The core 46 allows for sinkage of the plastic material of the bolt 14 when cooling.

The actuator 16 is a resilient member. As shown in FIG. 3, the actuator 16 is preferably positioned within the recess 36 of the bolt 14 although the actuator 16 could be positioned at other locations in the cavity 20. As shown in FIG. 4, the actuator 16 has a central hub 48 that receives the post 38 of the bolt 14 for pivotal support. A post 50 extends from the hub 48 to the top end 14a of the bolt 14 at the opening 22 (FIG. 7). A finger 51 extends from the post 50. As further shown in FIG. 4, the actuator 16 has a first leg 52 and a second leg 54 extending apart from the hub 48 towards the bottom end 14b of the bolt 14. The first leg 52 has a latch 56 having a cam surface 57. The latch 56 is configured to cooperate with the pin 26 of the first projection 24. The second leg 54 is configured to bias the latch 56 against the pin 26 and thus bias the actuator 16 into its first position AP1. As shown in FIGS. 3 and 6, the thickness of the actuator 16 is configured to fit flush within the recess 36 of the bolt 14 so as to allow the actuator 16 to fit through the opening 22 with the bolt 14. As the actuator 16 is pivotally supported by the post 38 of the bolt 14, the actuator 16 moves with the bolt 14 between the first position BP1 and the second position BP2. This configuration allows for a smaller cavity 20 and enhances the compact size of the window stop 10. It is appreciated that the actuator 16 could be supported within the recess 36 in other non-pivotal manners to lock the bolt 14 within the housing 12.

It is to be understood, that the window stop 10 could incorporate any type of bolt 14 and still remain with the scope of the present invention. This includes any of the bolts of the window stops discussed above in the background portion of this specification. It could include a pawl rotatably mounted within the housing 12, similar to that shown in FIG. 17. It could also include any style or configuration of slidably mounted bolt. Additionally, it is understood that the actuator 16 performs a function of releasably holding the bolt 14 in its retracted position substantially within the housing 12. Other means for releasably holding the bolt in the retracted position than that depicted in the figures could be utilized while remaining within the scope of the invention. For instance, in the case of a rotatably mounted pawl, the means for releasably holding could comprise a portion or edge of the pawl being adapted to engage or interfere with an interior surface of the cover 32. Also, the actuator 16 does not need to be mounted to or integral to the bolt 14. It could be mounted to the housing 12 and cooperate with the bolt 14 to selectively engage the bolt 14. Also, the stop 10 could include an internal actuator mechanism such that upon pushing the bolt 14 into the housing causes the mechanism to release the bolt 14 and allow it to extend out of the housing 12. To return the bolt to its retracted position, an operator would push it back into the housing whereupon the mechanism would re-engage the bolt to hold it within the housing 12.

As shown in FIG. 4, a spring 58 is positioned between the bolt 14 and the housing 12 to bias the bolt 12 to its second position BP2. Specifically, the spring 58 is positioned within the slot 42 of the bolt 14, thereby being contained within the slot 42. The spring 58 is further positioned between the projections 24, 28 and ribs 29 to prevent the spring 58 from sliding along the backwall of the housing 12. Although a coil spring is shown in FIGS. 2-5, other types of springs could also be used. In addition, other types of resilient members such as those made from rubber material could be used to bias the bolt to its second position BP2.

The housing 12 and bolt 14 have engaging surfaces in the form of a series of tongue and groove arrangements when the bolt 14 is in its second position BP2. The tongue and groove arrangements transfer forces from the bolt 14 to the housing 12 when the extended bolt (BP2) receives forces from contact with the sliding window. As shown in FIG. 7, the housing 12 has housing tongues 60 located towards opposite ends of the cavity 20. The housing tongues 60 extend downwardly from the internal surfaces 44. The locators 35, used to help position the cover plate 31 during assembly, extend outward from the housing tongues 60 (FIGS. 3, 4 and 6). The bolt 14 has bolt grooves 62 located towards opposite ends at the bottom end 14b of the bolt 14. As shown in FIG. 8, the housing tongues 60 are configured to cooperate with the bolt grooves 62 when the bolt 14 is extended to its second position BP2.

As further shown in FIG. 7, the housing 12 also has a pair of housing grooves 64 (openings shown in phantom) located adjacent to the housing tongues 60 towards opposite ends of the cavity 20. A lip 66 (FIG. 3) is located around a peripheral opening of the housing groove 64. The bolt 14 has bolt tongues 68 located adjacent to the bolt grooves 62 at the bottom end 14b of the bolt 14. The bolt tongues 68 also have recessed portions 70 (FIG. 3). As shown in FIG. 8, the housing grooves 64 are configured to cooperate with the bolt tongues 68 when the bolt 14 is extended to its second position BP2. In addition, the recessed portions 70 engage the lips 66 of the housing grooves 64.

Thus, when the bolt 14 extends to its second position BP2 (FIG. 8), housing tongues 60 cooperate with bolt grooves 62, housing grooves 64 cooperate with bolt tongues 68 and recessed portions 70 cooperate with lips 66. These engaging surfaces provide a surface area over which forces from contact with a sliding window may be transferred from the bolt 14 to the housing 12. These engaging surfaces further reinforce the stability of the window stop 10 when the bolt 14 is in its second position BP2. It is understood that a single tongue and groove arrangement could be used as well as a single arrangement on only one side of the window stop 10. It is preferred, however, that two of each pairs of engaging surfaces 60,62; 64,68 and 66,70 be used to maximize the strength and stability of the window stop 10.

In addition, the housing 12, bolt 14 and actuator 16 are all manufactured to very close tolerances. The engaging surfaces 60,62; 64,68 and 66,70 are also manufactured to very close tolerances. The parts interfit very closely to increase the already large and resistive areas over which forces may be transferred. Also, the housing 12 and bolt 14 are molded of a high strength, high impact resistant plastic material, such as polycarbonate.

To assemble the window stop 10, the actuator 16 is first positioned into the recess 36 of the bolt 14. The bolt 14 is then inserted into the opening 20 of the housing 12. The spring 58 is then positioned in the slot 42 of the bolt 14 and between the projections 24,28 and pair of ribs 29 on the housing 12. Finally, the cover plate 31 is joined to the housing 12 in an interference fit to enclose the bolt 14 and actuator 16 in the housing 12. A unitary structure is thus formed. The window stop 10 is then ready for shipment and installation into a window assembly by a window manufacturer.

The operation of the universal window stop 10 will now be described in detail, to be followed by a detailed description of the installation of the window stop 10. This description of the operation will be made presuming the universal window stop 10 is generally installed in a similar location as FIG. 1 depicts the prior art window stop 11 installed in the window assembly 1.

Once installed in upper sash 3, the window stop 10 can be operated to limit movement of both the upper sash 3 and lower sash 4. The window stop 10 is first configured as shown in FIGS. 3 and 4, wherein the bolt 14 is in its first position BP1, out of the path of sliding window movement of sash 4, and preferably substantially flush with the faceplate 32 for enhanced appearance. In this position, the actuator 16 is in its first position AP1 where the latch 56 on the actuator 16 is coupled to the pin 26 on the housing 12. In this position, the actuator 16 holds the bolt 12 in its first position BP1 against the outward bias of the spring 58.

When it is desired to limit movement of the sliding window, the actuator 16 is operated, through the opening 22, to allow the bolt to extend to its second position BP2. To this end, as shown in FIG. 7, a person manually rotates the actuator 16 clockwise, as shown by the arrows A, to its second position AP2. As shown in FIG. 3, the actuator 16 may have an arrow 53 integrally molded into the post 50 to direct the person in the direction of rotation of the actuator 16. The bevelled surface 47 on the bolt 14 (FIG. 3) assists in the person's finger easily rotating the actuator 16. As further shown in FIG. 7, the inclined surface 40 of the bolt recess 36 allows the actuator 16 to be pivoted. The notch 41 of the bolt 14 receives the finger 51 of the actuator 16 when the actuator 16 is pivoted to its second position AP2. Also, as shown in FIGS. 3 and 8, the finger 52 covers the recess 36 at the top end 14a of the bolt to prevent debris or other material from falling into the recess 36 through the opening 22.

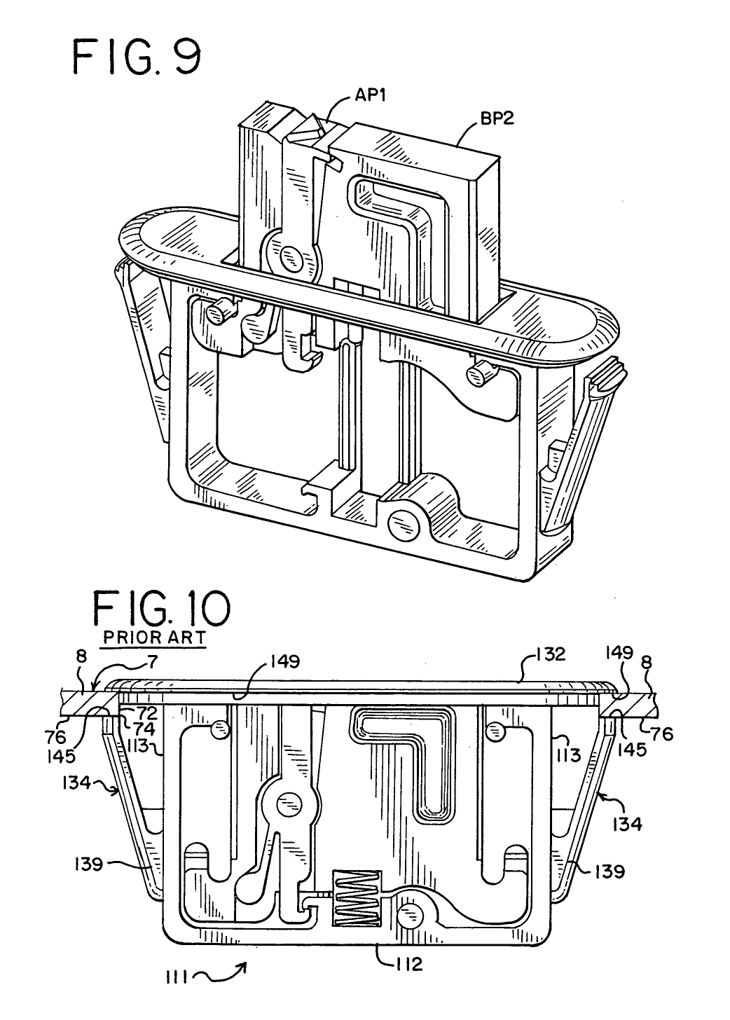

As the actuator 16 is pivoted about the hub 48 and post 36 to its second position AP2 (FIG. 7), the latch 56 disengages from the pin 26. As shown in FIGS. 8 and 9, the spring 58 then extends to immediately drive the bolt 14 out of the opening 22 to its second position BP2. Preferably, the bolt 14 has an extension of at least ½ inch from the stile 7 or track 13 of a window frame. In this position, the bolt 14 is in the path of sliding window movement of the other or lower sash 4. The resilient second leg 54 of the actuator 16 engages a wall of the recess 36 biasing the latch 16 back to its first position. Because each of the upper and lower sashes 3, 4 are mounted for sliding movement within the master frame 2, when the bolt 14 is in the extended position, the window stop 10 limits the extent of sliding movement of each sash 3, 4. Further, it can be seen that the extent to which such movement is limited by the stop 10 is determined by the vertical positioning of the stop 10 on the stile 7.

With the bolt 14 extended to its second position BP2, the housing tongues 60 extend into and engage the cooperating bolt grooves 62. The housing grooves 64 receive and engage the cooperating bolt tongues 68. In addition, the recessed portions 70 on the bolt tongues 68 engage the lips 66 at the periphery of the housing grooves 64. This construction gives the bolt 14 increased stability when in its second position BP2. When a sliding window contacts the bolt 14, sometimes at high impact, the engaging surfaces 60, 62; 64, 68 and 66, 70 transfer the forces received from the sliding window from the bolt 14 to the housing 12. Because these engaging surfaces provide a larger resistive area over which forces may be transferred, the window stop 10 of the present invention is able to absorb higher forces from sliding windows than some conventional window locks having a rotating tumbler. In addition, the bolt 14 extends directly out of the housing along a linear axis rather than rotating out of the housing like a tumbler. Therefore, tumbler overrotation is eliminated. The bolt 14 receives the forces from the sliding window and efficiently transfers the forces to the housing via the engaging surfaces 60, 62, 64, 68 and 66, 70.

When it is no longer desired to limit movement of the sliding window, the bolt 14 is returned to its first position BP1 by pushing the bolt back into the housing 12 through opening 22. As the bolt 14 is pushed into the housing against the outward bias 10 of the spring 58, the cam surface 57 of the actuator latch 56 engages the cam surface 27 of the pin 26 on the first projection 24. These surfaces cooperatively engage to pivot the actuator 16 towards is second position AP2. As the bolt 14 is pushed further into the housing 12, the latch 56 passes the pin 26. The second leg 54 of the actuator 16 then biases the actuator 16 to its first position AP1 where the latch 56 engages the pin 26 and locks the bolt 14 in its first position BP1. When it is again desired to limit movement of the sliding window, the window stop is again operated as described above.

Thus, an improved window stop is provided. Because the housing 12 only requires a single cavity 20, the window stop is very compact in size. While it is not imperative that the actuator 16 be carried by the bolt 14, this configuration is preferred. With the actuator 16 carried in the recess 36 of the bolt 14, the compact size of the window stop 10 is greatly increased. The tongue and groove arrangements between the housing 12 and bolt 14 allow the window stop 10 to absorb increased forces from contact with the sliding window thereby increasing its useful life and its possible applications. Furthermore, as shown above, the window stop is easy to operate. An important application of the stop of the present invention is for limiting the movement of sliding windows. It is appreciated, however, that the stop could also be used to limit the movement of other types of sliding members, other than sliding windows.

Additional features of the housing 12 that allow the housing 12 to be installed or mounted in a window assembly 1, 9 will now be described in more detail.

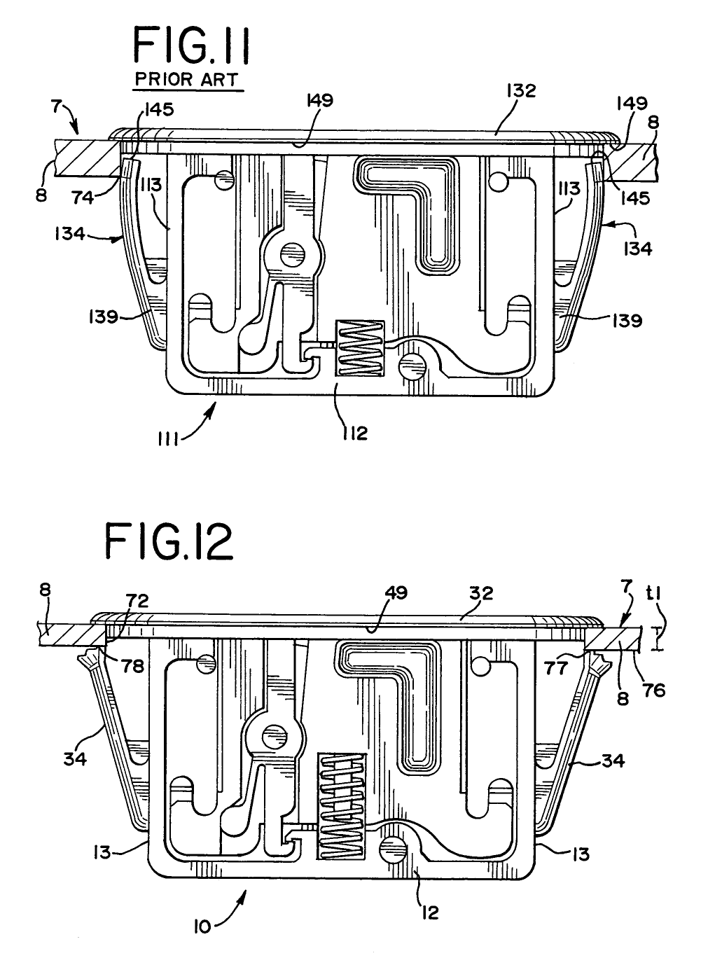

FIGS. 10-11 show a prior art window stop 111 installed in a frame member. The window stop 111 has a prior art housing 112. The housing 112 has a face plate 132 extending beyond the housing 112 to form a generally peripheral lip 149 and a pair of end walls 113. The housing 112 further has a pair of resilient tabs 134. Each tab 134 has a base portion 139 mounted to a respective end wall 113 and an engagement surface 145 distal from the base portion 139. Each engagement surface 145 is spaced from and generally opposed to the lip 149. Additionally, the engagement surface 145 is a planar surface and generally parallel with the lip 149. The tabs 134 are configured to be spaced a distance slightly greater than the expected thickness of the front wall 8 of the stile 7 to which the stop 111 is being mounted.

To install the stop 111 in the stile 7, the housing 112 is inserted into an aperture 72 in the stile 7 (see also, FIG. 17). As the housing 112 is being inserted, the front wall 8 causes the tabs 134 to flex towards their respective end walls 113. Once the engagement surfaces 145 move past an inside aperture edge 74, the tabs 134 spring back to their original or un-flexed position such that the engagement surfaces 145 are adjacent to and substantially abut and oppose an inner surface 76 of the front wall 8. In this way, the wall 8 is received between the lip 149 and the engagement surface 145.

It can be seen that this arrangement of the prior art allows for each window stop 111, or housing 112 thereof, to be installed in walls having essentially a single thickness. That is, if the housing 112 is installed in a wall 8 having too large a thickness, as shown in FIG. 1, the tabs 134 are not able to return to their original or un-flexed position. Consequently and the wall 8 is never received between the lip 149 and the engagement surfaces 145. Accordingly, the housing 112 of FIG. 11 is not properly mounted to or secured to the wall 8 within the stile 7. A wall 8 having too great a thickness would be one that has a thickness slightly greater than the distance between the lip 149 and engagement surface 145.

A wall 8 having too thin of a thickness would be one that had a thickness sufficiently smaller than the distance between the lip 149 and the engagement surface 145. Installation of the window stop 111 in too thin of a wall 8 or frame member is undesirable because it would permit the housing 112 and stop 111 to rattle within the wall. Also, a loose installation would compromise the effectiveness of the stop to transfer forces generated by the lower sash 4 thought the bolt 114, through the housing 112 and ultimately to the stile 7.

Referring to FIGS. 4, and 12-15, it can be seen that the engagement surfaces 45 of the housing 12 of the present invention are inclined with respect to the lip 49 and face generally away from their respective end walls 13. Additionally, each inclined engagement surface 45 comprises a first, second and third ridge 78, 80 and 82, each of which being located successively further away from the lip 49 than its predecessor. That is, the second ridge 80 is slightly further from the lip 49 than is the first ridge 78, and the third ridge 82 is slightly further from the lip 49 than is the second ridge 80. Disposed among and/or between the ridges 78, 80, 82 are a first confronting surface 77, second confronting surface 79 and third confronting surface 81. It will be seen that the arrangement of the lip 49, ridges 78, 80, 82 and confronting surfaces 77, 79, 81 permits the housing 12 to be installed in a wall 8 having a thickness within a range of thickness from a minimum to a maximum thickness. Thus a single housing 12 can be installed in a wall 8 or frame member that is selected from a plurality of walls having varying thickness in a range from a minimum thickness to a maximum thickness. The engagement surfaces 45 may also be considered to be variable surfaces that can include a stepped configuration or an angled configuration. The engagement surfaces 45 are in confronting and spaced relation to the cover of the housing 12. The variable engagement surfaces 45 cooperate with the cover of the housing 12 to receive walls 8 of frame members having variable surfaces.

To install the stop 10 of the present invention in a stile 7, the housing 12 is inserted into an aperture 72 in the stile 7 (See FIG. 12). The wall or frame member 8 has a thickness of t1. As the housing 12 moves into the aperture 72, the wall 8 forces the tabs 34 to flex inwards towards the end walls 13. As the engagement surface 45 begins to pass by an inside aperture edge 74, the tabs 34 begin to return towards their un-flexed position. FIG. 12 shows the housing 12 installed in a wall 8 of a particular thickness t1 such that the wall is generally received and held between the lip 49 and the first ridge 78. The particular thickness t1 of the wall 8 shown allows the tabs to substantially fully return to their pre-flexed positions. Also, the first confronting surface 77 generally opposes or confronts the inner surface 76 of the wall 8.

FIG. 13 shows the housing 12 installed in a wall 8 having a thickness t2 greater than that shown in FIG. 12. To install the stop 10 in the wall 8 of FIG. 13 having thickness t2, the housing 12 is inserted into the aperture 72. The wall 8 flexes the tabs 34 towards their respective end walls 13. As the inclined engagement surfaces 45 begin to pass by the inside aperture edge 74, the tabs 34 begin to return towards their un-flexed position. Because the wall 8 of FIG. 13 has a slightly greater thickness t2 that the thickness t1 of FIG. 12, the tabs 34 remain more flexed than they do when installed in the wall 8 of FIG. 12 having thickness t1. Accordingly, the wall 8 of FIG. 13 is generally received between the lip 49 and the second ridge 80 of the inclined engagement surface 45 of the tab 34. Also, the second confronting surface 79 generally confronts or opposes the inner surface 76 of the wall 8.

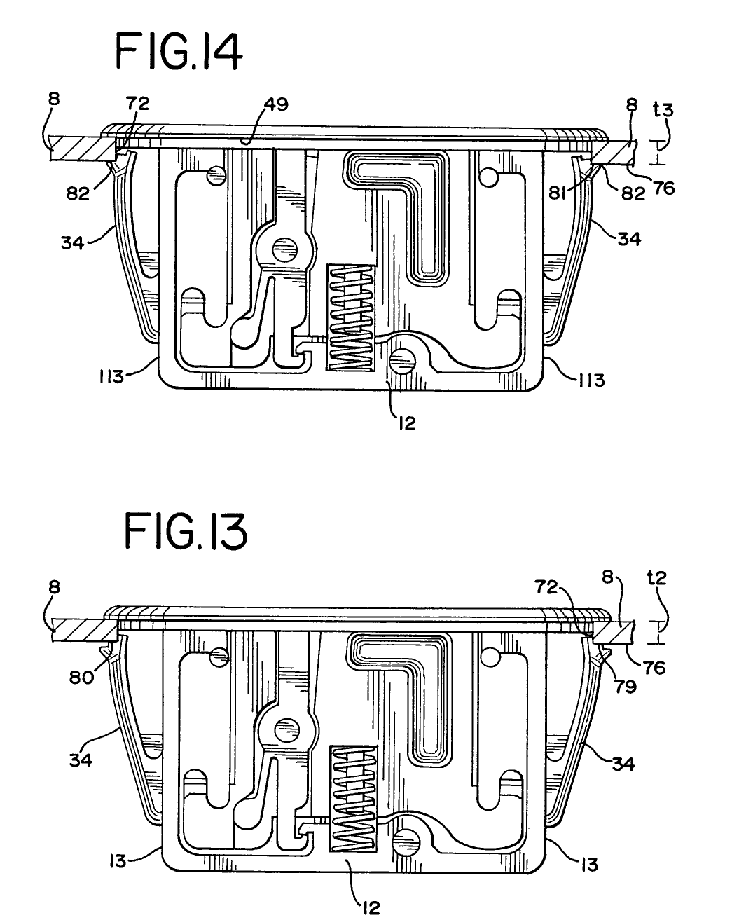

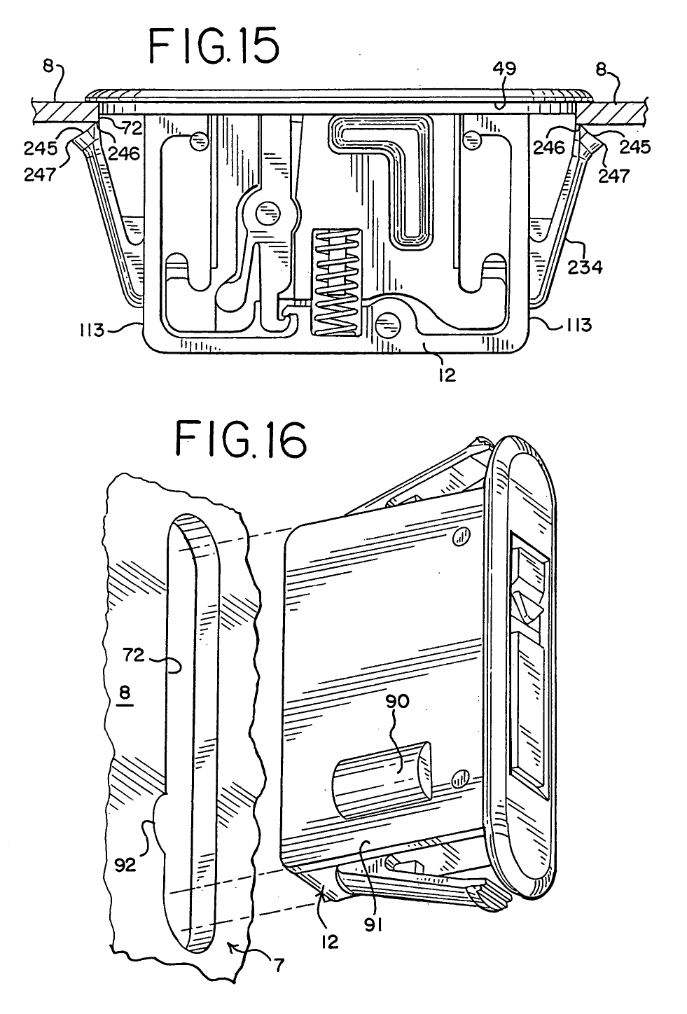

FIG. 14 shows the housing 12 installed in a wall 8 having a thickness slightly greater than that shown in FIG. 13. To install the stop 10 in the wall 8 of FIG. 14 having thickness t3, the housing 12 is inserted into the aperture 72. The wall 8 flexes the tabs 34 towards their respective end walls 13. As the inclined engagement surfaces 45 begin to pass by the inside aperture edge 74, the tabs 34 begin to return towards their un-flexed position. Because the wall 8 of FIG. 14 has a greater thickness t3 than the thickness t2 of FIG. 13 or the thickness t1 of FIG. 12, the tabs 34 remain more flexed than they do when installed in the wall 8 of FIG. 12 having thickness t1 or the wall 8 of FIG. 13 having thickness t2. It can be seen the wall 8 of FIG. 14 is generally received between the lip 49 and the third ridge 82 of the inclined engagement surface 45 of the tab 34. Also, the third confronting surface opposes and/or generally confronts the inner surface 76 of the wall 8.

It can be seen then that the mount structure of the housing 12, the lip 49 and tabs 34, is adapted to receive any wall 8 having a thickness between a minimum and a maximum thickness. A minimum thickness would be one capable of being received between the first ridge 78 and the lip 49 without allowing excessive rattling or movement of the housing 12 within the aperture 72. A maximum thickness would be one capable of being received between the third ridge 82 and the lip 49. It is noted that the mount structure is adapted to receive of wall 8 of any thickness between the minimum thickness and the maximum thickness.

FIG. 15 shows a housing 12 having tabs 234 having an alternative inclined engagement surface 245. The embodiment of FIG. 15 shows an engagement surface 245 having no ridges, but rather one that is substantially smooth. The engagement surface 245 is inclined between a first inner edge 246 and a second outer edge 247. The outer edge 247 is located further from the lip 49 than is the inner edge 246. As previously described, the inclined engagement surfaces 245 generally face away from their respective end walls 113.

FIG. 15 further shows the housing 12 installed in a wall 8. The wall 8 is generally received between the inner edge 246 of the inclined engagement surfaces 245 and the lip 49. The mount structure of this embodiment can receive a wall having a minimum thickness to a maximum thickness. A minimum thickness would be one wherein the wall 8 could be received between the lip 49 and the inner edge 246 without allowing excessive movement or rattling of the housing within the aperture 72. A maximum thickness would be one wherein the wall could be generally received between the lip 49 and the outer edge 247. Thus the mount structure is adapted to receive any wall 8 having a thickness chosen from a plurality of walls 8 between the minimum thickness and the maximum thickness. For thicknesses between the minimum and maximum thickness, the inside aperture edge 74 would engage the inclined engagement surface 245 somewhere generally between the inner edge 246 and the outer edge 247.

Additionally, the engagement surfaces 45, 245 could include a plurality of protrusions extending therefrom or it could comprise an otherwise textured surface.

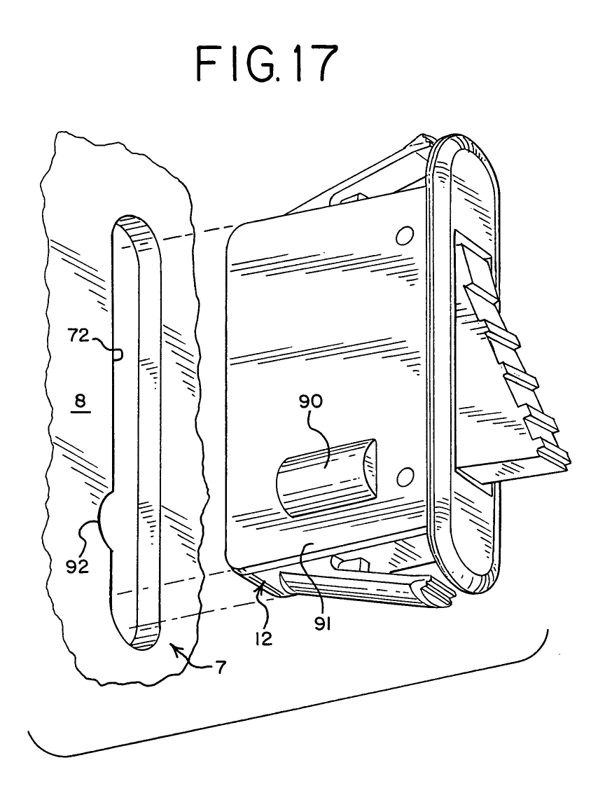

FIG. 16 shows an additional feature of the housing 12 of the present invention. An extension member or bump 90 extends from an exterior surface 91 of the housing 12. The aperture or recess 72 of the front wall 8 of the stile 7 also includes a notch 92. Upon installation of the housing 12 of FIG. 16 into the aperture 72, the notch 92 receives the bump 90 and allows the bump 90 to pass through the notch 92. The cooperation of the bump 90 and notch 92 permit the housing 12 to be inserted into the aperture 72, and therefore to be installed in the stile 7, in but a single orientation. It is preferred, particularly when installing this stop 10 in a vertically sliding double hung window assembly 1, that it be oriented such that the arrow 53 of the actuator 16 is pointing down. In this orientation, to actuate the stop 10 and release the bolt from the housing 12, the arrow 53 needs to be moved in a downward direction. It has been found that moving the arrow 53, and thus the actuator 16, in a downward direction for actuation is preferable and more comfortable for the typical user or consumer.

While particular embodiments of the invention have been shown and described, it will be obvious to those skilled in the art that changes and modifications of the present invention, in its various aspects, may be made without departing from the invention in its broader aspects, some of which changes and modifications being matters of routine engineering or design, and others being apparent only after study. As such, the scope of the invention should not be limited by the particular embodiment and specific construction described herein but should be defined by the appended claims and equivalents thereof. Accordingly, the aim in the appended claims is to cover all such changes and modifications as fall within the true spirit and scope of the invention.

1. A widow stop comprising:
a housing defining a cavity and having mount structure capable of being mounted to a wall having a thickness between a range of thicknesses from a minimum thickness to a maximum thickness;
a bolt mounted within the cavity and moveable between a retracted position wherein the bolt is substantially located within the housing and a locking position wherein the bolt extends from the cavity.

2. The window stop of claim 1 further comprising means for releasably holding the bolt in the retracted position.

3. The window stop of claim 1 further including biasing means between the housing and the bolt for biasing the bolt towards the extended position.

4. The window stop of claim 1 wherein the mount structure further comprises:
a cover defining a lip; and
a resilient tab having a base portion mounted to an end wall of the housing and an engagement surface spaced from and in opposed relation to the lip wherein the lip and the surface are configured to receive a portion of the wall therebetween.

5. The window stop of claim 4 wherein the engagement surface is inclined with respect to the lip.

6. The window stop of claim 4 wherein the engagement surface is generally adapted to face away from the end wall.

7. The window stop of claim 4 wherein the engagement surface comprises a ridge.

8. The window stop of claim 4 wherein the engagement surface comprises two ridges.

9. The window stop of claim 4 wherein the engagement surface comprises three ridges.

10. The window stop of claim 4 wherein the engagement surface comprises a plurality of ridges.

11. The window stop of claim 4 wherein the engagement surface comprises a protrusion.

12. The window stop of claim 4 wherein the engagement surface comprises a plurality of protrusions.

13. The window stop of claim 1 wherein the bolt slides generally linearly between the retracted position and the locking position.

14. The window stop of claim 1 wherein the bolt rotates between the retracted position and the locking position.

15. The window stop of claim 1 wherein the housing further comprises an extension member extending from an exterior surface of the housing.

16. The window stop of claim 15 wherein the extension member is adapted to cooperate with a notch in an opening of the wall.

17. A housing of a window or door hardware component, the housing being mounted in a recess of a frame member, the frame member having a thickness, the housing comprising:
a body having a cover defining a lip, the body further having a tab having an inclined engagement surface in spaced relation to the lip, wherein the engagement surface and lip are adapted to cooperatively engage the frame member, the frame member selected from one of a plurality of frame members having a minimum thickness and a maximum thickness.

18. The housing of claim 17 wherein the engagement surface generally faces away from an end wall of the housing.

19. The window stop of claim 17 wherein the engagement surface comprises a plurality of ridges.

20. The window stop of claim 17 wherein the engagement surface comprises a protrusion.

21. The window stop of claim 17 wherein the engagement surface comprises a plurality of protrusions.

22. A widow stop comprising:
a housing defining a cavity and having means for mounting the housing to a wall having a thickness chosen from any of a plurality of thicknesses within a range of thicknesses between a minimum thickness and a maximum thickness;
a bolt mounted within the cavity and moveable between a retracted position wherein the bolt is substantially located within the housing and a locking position wherein the bolt extends from within the cavity;
means for releasably holding the bolt in the retracted position; and
biasing means between the housing and the bolt for biasing the bolt towards the extended position.

23. A widow stop for use in a window assembly having an upper sash and a lower sash, each sash slidably mounted in a master frame, each sash having a top rail a bottom rail and a pair of vertical stiles, each vertical stile having a front wall, the window stop comprising:
a housing defining a cavity, the housing having a cover defining a lip, the housing further having a tab having an inclined engagement surface in spaced relation to the lip, wherein the engagement surface and lip are adapted to cooperatively engage the frame member, the frame member being any of a plurality of frame members having a thickness between a minimum thickness and a maximum thickness, the housing further having a projection extending into the cavity;
a bolt operably mounted within the cavity and moveable between a retracted position wherein the bolt is substantially located within the housing and thereby out of a path of movement of the lower sash and an extended position wherein the bolt extends from within the cavity and into the path of movement of the lower sash;
means for biasing the bolt towards the extended position, and
an actuator pivotally mounted to the bolt having a hook at one end for engaging the projection to retain the bolt in the retracted position when the actuator is in a locked position, the actuator pivotable from the locked position to a release position wherein the hook disengages from the projection to permit the bolt to move towards the extended position.

24. A widow stop for use in a window assembly having an upper sash and a lower sash, each sash slidably mounted in a master frame, each sash having a top rail a bottom rail and a pair of vertical stiles, each vertical stile having a front wall, the window stop comprising:
a housing defining a cavity, the housing having a cover defining a lip, the housing further having a tab having an inclined engagement surface in spaced relation to the lip, the engagement surface comprising a plurality of ridges, wherein the engagement surface and lip are adapted to cooperatively engage the frame member, the frame member being any of a plurality of frame members having a thickness between a minimum thickness and a maximum thickness, the housing further having a projection extending into the cavity;
a bolt operably mounted within the cavity and moveable between a retracted position wherein the bolt is substantially located within the housing and thereby out of a path of movement of the lower sash and an extended position wherein the bolt extends from within the cavity and into the path of movement of the lower sash;
means for biasing the bolt towards the extended position, and
an actuator pivotally mounted to the bolt having a hook at one end for engaging the projection to retain the bolt in the retracted position when the actuator is in a locked position, the actuator pivotable from the locked position to a release position wherein the hook disengages from the projection to permit the bolt to move towards the extended position.

25. A widow stop comprising:
a housing defining a cavity and having a cover, the housing further having a tab in confronting relation to the cover wherein a space is defined therebetween, the tab having a variable surface wherein the tab and cover cooperate and are adapted to receive a wall having a variable thickness;
a bolt mounted within the cavity and moveable between a retracted position wherein the bolt is substantially located within the housing and a locking position wherein the bolt extends from the cavity.

26. The stop of claim 25 wherein the variable surface is a stepped surface.

27. The stop of claim 25 wherein the variable surface is an angled surface.

28. A housing of a window or door hardware component, the housing being mounted in a recess of a frame member, the recess further having a notch, the housing comprising:
a body defining configured for mounting within the recess, the body having an extension member configured to be received by the cutout.

29. The housing of claim 28 wherein the extension member and the cutout cooperate to properly orient the body within the recess.

30. A widow stop comprising:
a housing defining a cavity, the housing having an end wall and a cover defining a lip;
a tab having a base portion mounted to the end wall and extending away from the end wall, the tab having an engagement surface distal from the base portion, the engagement surface being spaced from the lip and inclined with respect to the lip; and
a bolt mounted within the cavity and moveable between a retracted position wherein the bolt is substantially located within the housing and a locking position wherein the bolt extends from the cavity.

31. The window stop of claim 30 wherein the engagement surface is spaced from the end wall.

32. The window stop of claim 30 wherein a distal end of the tab is spaced from the end wall when the tab is in an unflexed position.

33. The window stop of claim 30 wherein the engagement surface is substantially smooth.

34. A widow stop comprising:
a housing defining a cavity, the housing having a pair of end walls and a cover defining a lip;
a pair of tabs each having a base portion mounted to a respective end wall and extending away from its respective end wall, each tab having a smooth engagement surface distal from its base portion, each smooth engagement surface being spaced from the lip and inclined with respect to the lip; and
a bolt mounted within the cavity and moveable between a retracted position wherein the bolt is substantially located within the housing and a locking position wherein the bolt extends from the cavity;
wherein a distal end of each tab is spaced from its respective side wall when the tab is in an unflexed position.
